(19) United States
(12) Patent Application Publication
(10) Pub. No.: US 2025/0100357 A1
(43) Pub. Date: Mar. 27, 2025

(54) TONNEAU COVER WITH LINKAGE FREE BOW SYSTEM

(71) Applicant: Bestop, Inc., Louisville, CO (US)

(72) Inventor: Tavis Lutzka, Rochester Hills, MI (US)

(73) Assignee: Bestop, Inc., Louisville, CO (US)

(21) Appl. No.: 18/898,011

(22) Filed: Sep. 26, 2024

Related U.S. Application Data
(60) Provisional application No. 63/585,455, filed on Sep. 26, 2023.
(60) Provisional application No. 63/591,262, filed on Oct. 18, 2023.

(51) Int. Cl. B60J 7/12; E05D 15/26; E05D 15/40; E05D 15/46

(52) U.S. Cl. CPC B60J 7/12; E05D 15/26; E05D 15/403; E05D 15/46; E05Y 2900/53

(57) ABSTRACT

A tonneau cover assembly including a plurality of biasing pivots assisting and operably dampening the movement of a plurality of fabric management bows when moving the tonneau cover between a closed position and open position and back. Biasing pivots help to load the plurality of fabric management bows and, when the tonneau cover is opening, the bows manage the fabric. According to aspects of the present invention, at least two pairs of biasing pivots are biased away from each other to maintain tonneau cover fabric tension. At least one addition biasing pivot dampens the fall of the plurality of fabric management bows opening and also assists with the tonneau cover assembly's balance when closing and prevent binding.

### CROSS-REFERENCE TO RELATED APPLICATIONS

This application is a Non-Provisional Patent Application which claims the benefit of U.S. Provisional Patent Application No. 63/585,455, filed Sep. 26, 2023 and U.S. Provisional Patent Application No. 63/591,262, filed Oct. 18, 2023. The disclosures of the above applications are incorporated herein by reference.

### FIELD OF THE INVENTION

The present invention relates to a soft tonneau cover with a linkage-free bow system.

### BACKGROUND OF THE INVENTION

Openable and stowable soft tonneau covers for pickup vehicles are known in the art. These tonneau covers provide access to the cargo bed of the vehicle when the cover is at least partially opened, and provide covered protection from the elements when the cover is closed. Some typical tonneau covers may be folded or rolled open. Tonneau covers require the user to perform a series of manipulations of the cover to open and closed positions and the management of the soft cover materials during folding.

Therefore, there remains a need in the art to provide a tonneau cover top cargo bed opening cover with assisted opening/closing and improved fabric management.

### SUMMARY OF THE INVENTION

A tonneau cover assembly having a plurality of biasing pivots, assists the movement of a plurality of fabric management bows when moving the tonneau cover between a closed position and open position and back. Biasing pivots, e.g., spring biased, helps to load the bows, and when the tonneau cover is opening, the bows manage the fabric. According to aspects of the present invention, at least two pairs of biasing pivots are biased away from each other to maintain tonneau cover fabric tension. At least one, preferably at least one pair, of biasing pivots, e.g., spring biased, dampen the fall of a pivotable portion opening and also assists with the assembly's balance when closing.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

The present invention will become more fully understood from the detailed description and the accompanying drawings, wherein:

FIG. 1 is a perspective view of a tonneau cover assembly in an exemplary closed position illustrated in an environment of use, in accordance with the present invention;

FIG. 2 is a bottom plane view of the tonneau cover in the exemplary closed position illustrated in an environment of use;

FIG. 3 is a perspective view of the tonneau cover with the cover removed for clarity;

FIG. 4 is an enlarged view of FIG. 3;

FIG. 5 is a perspective view of the tonneau cover assembly in the closed position, with the cover removed for clarity, illustrated in the environment of use, in accordance with the present invention;

FIG. 6 is a side elevation view of the tonneau cover assembly in the closed position;

FIGS. 7, 9, and 11 are perspective views of the tonneau cover assembly opening;

FIGS. 8, 10, and 12 are side elevation views of the tonneau cover assembly opening;

FIG. 13 is a perspective view of the tonneau cover in an exemplary open position; and

FIG. 14 is a side elevation view of the tonneau cover in the open position.

### DETAILED DESCRIPTION OF THE PREFERRED EMBODIMENTS

Referring to the Figures generally, a fabric management tonneau cover assembly which is linkage free between the bows is provided in accordance with the present invention.

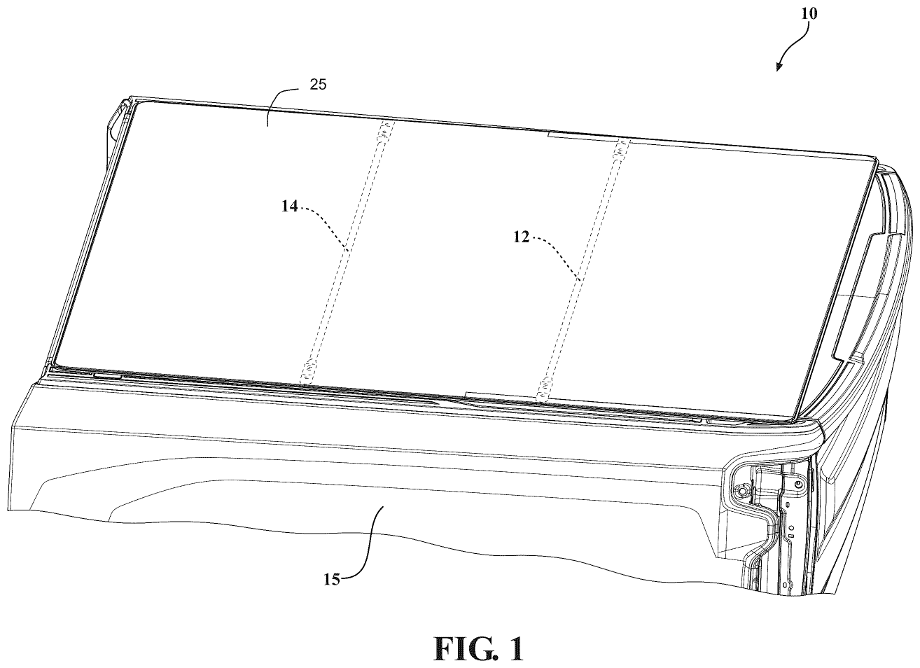

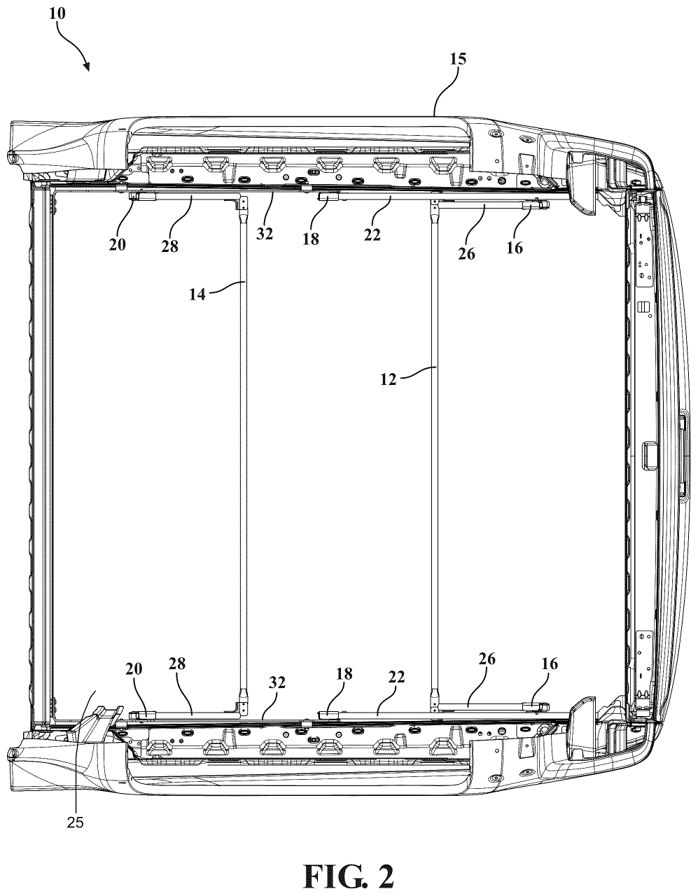

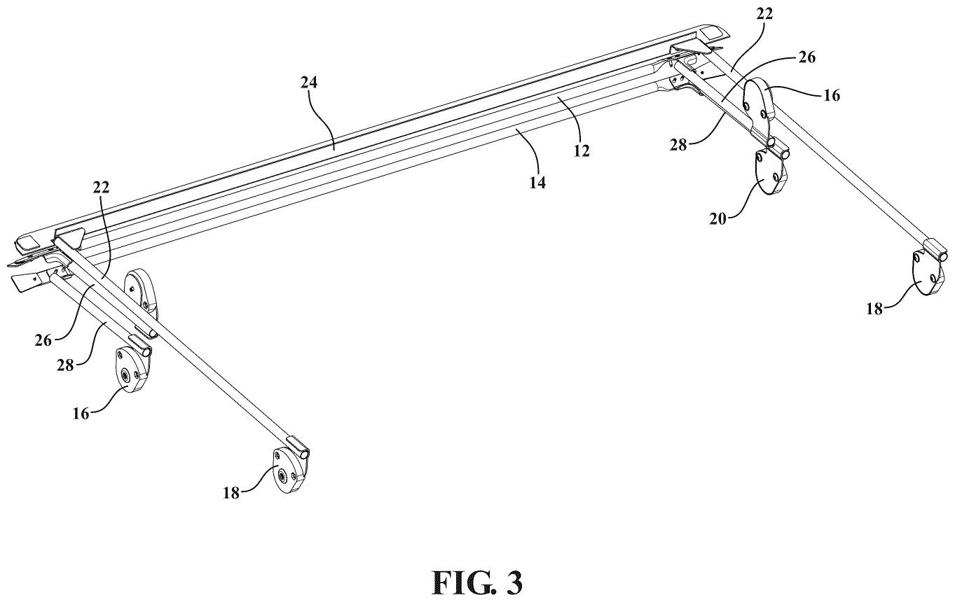

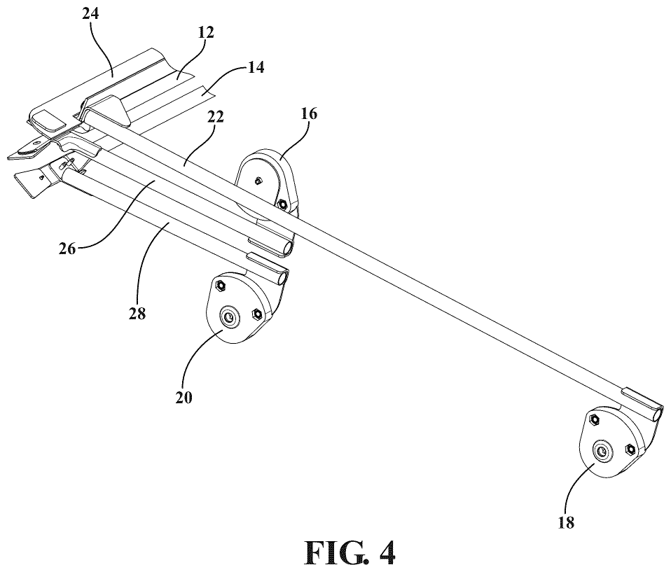

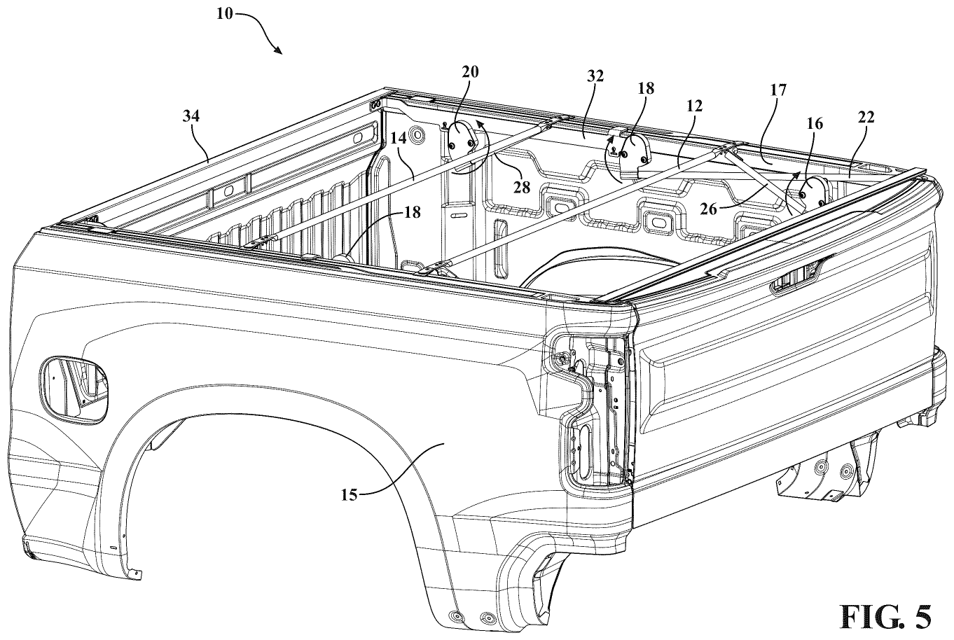

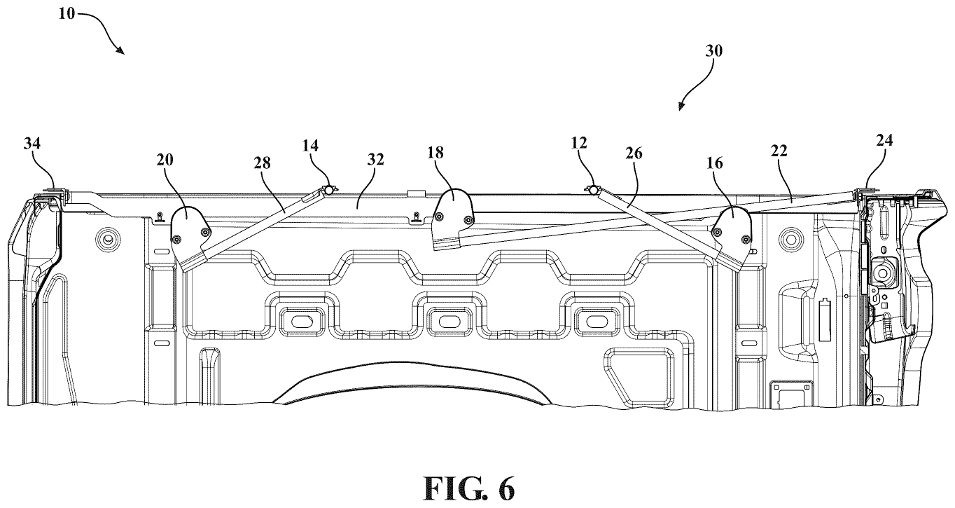

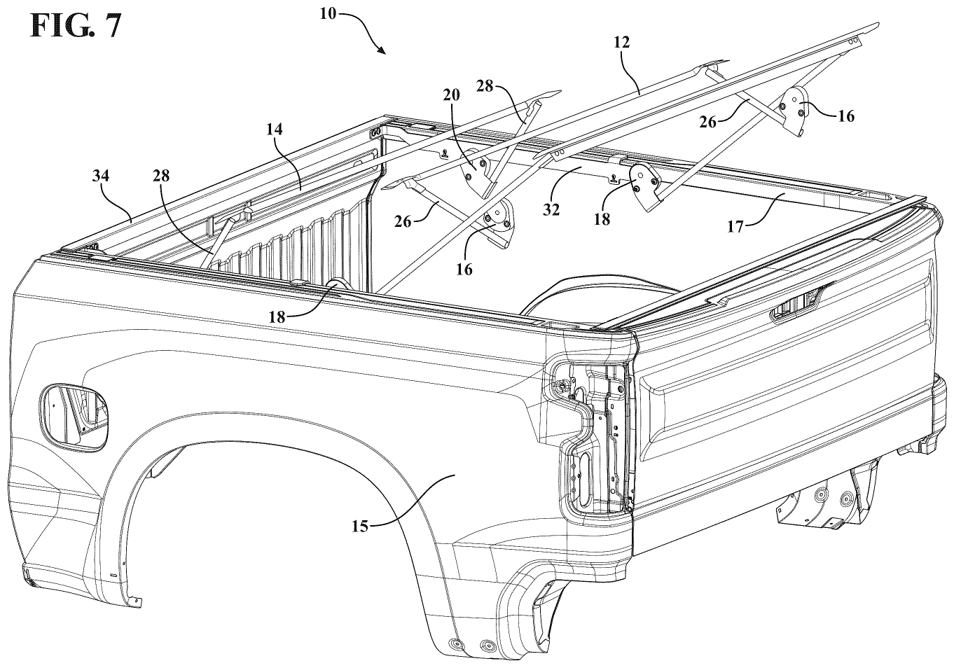

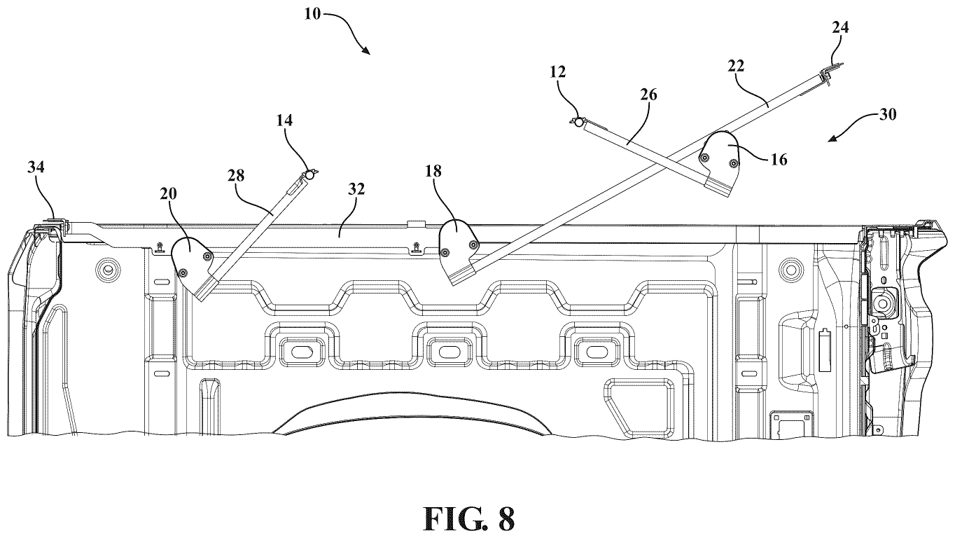

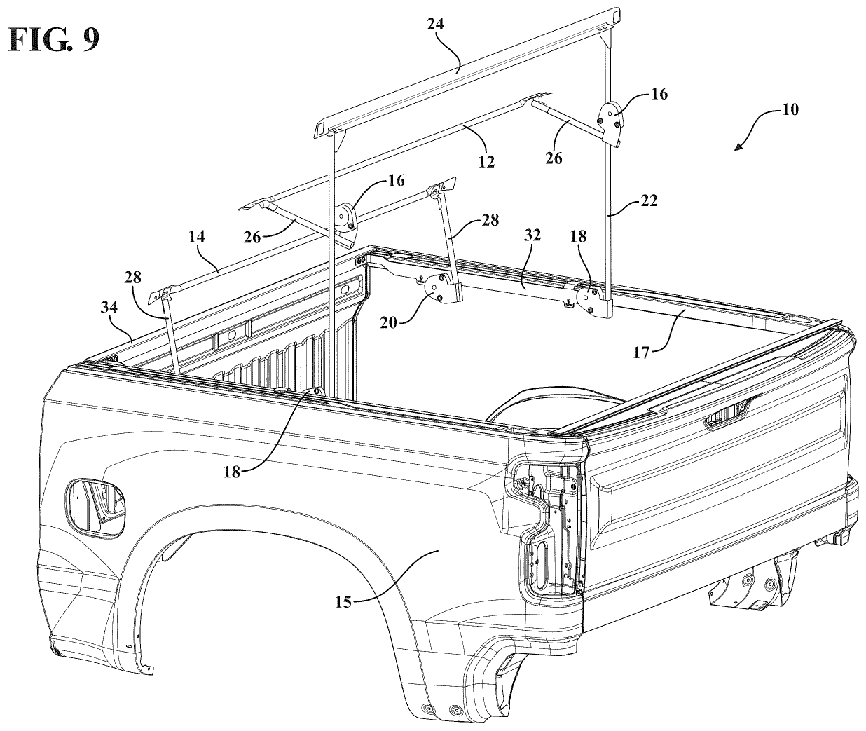

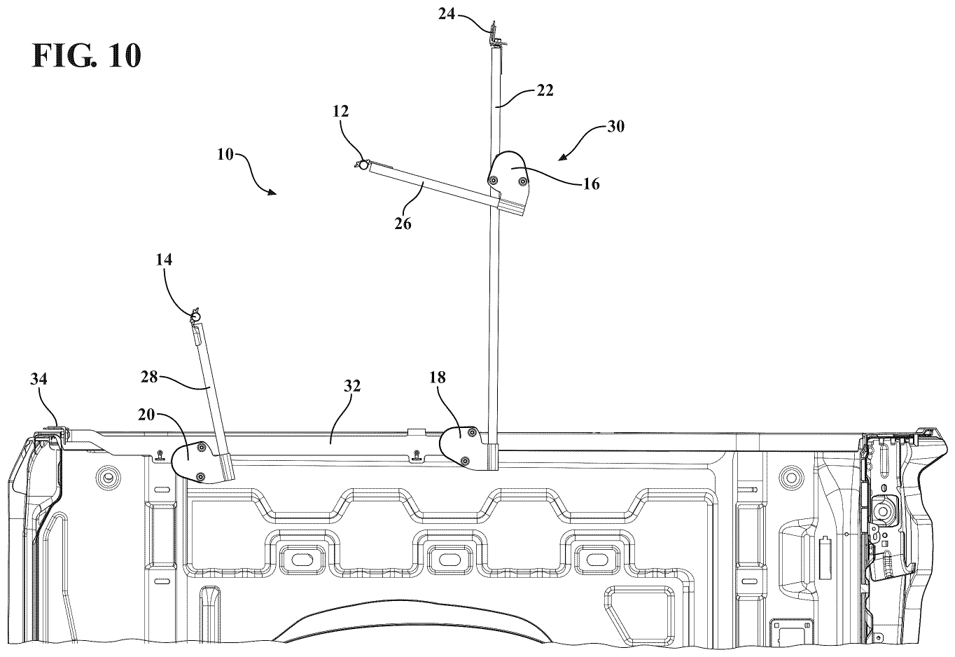

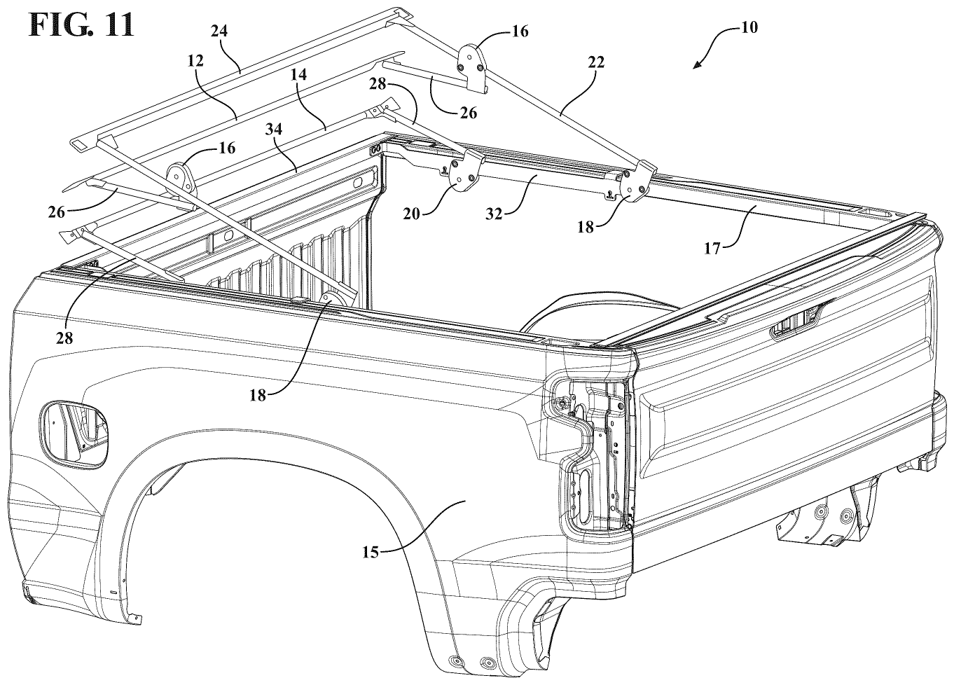

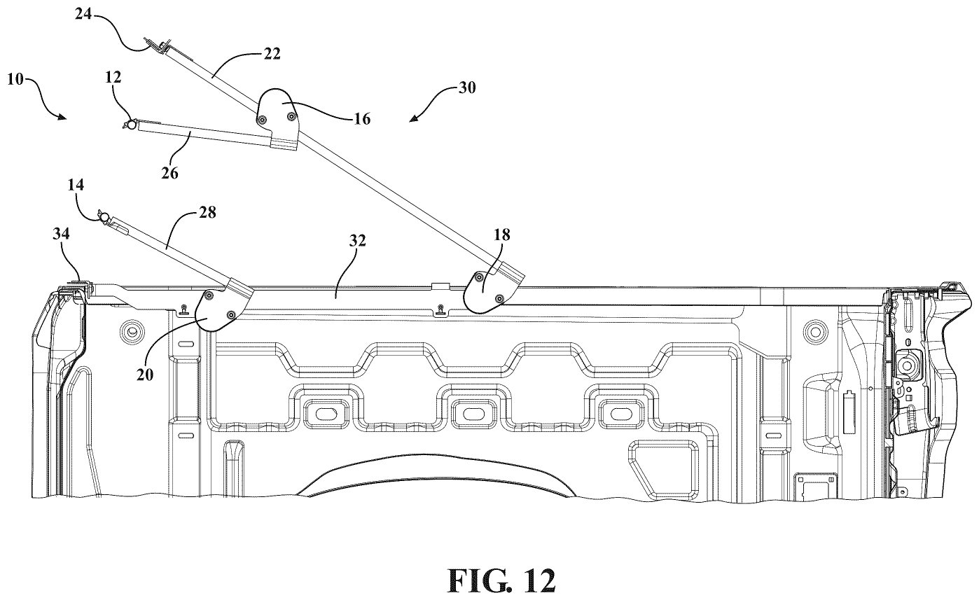

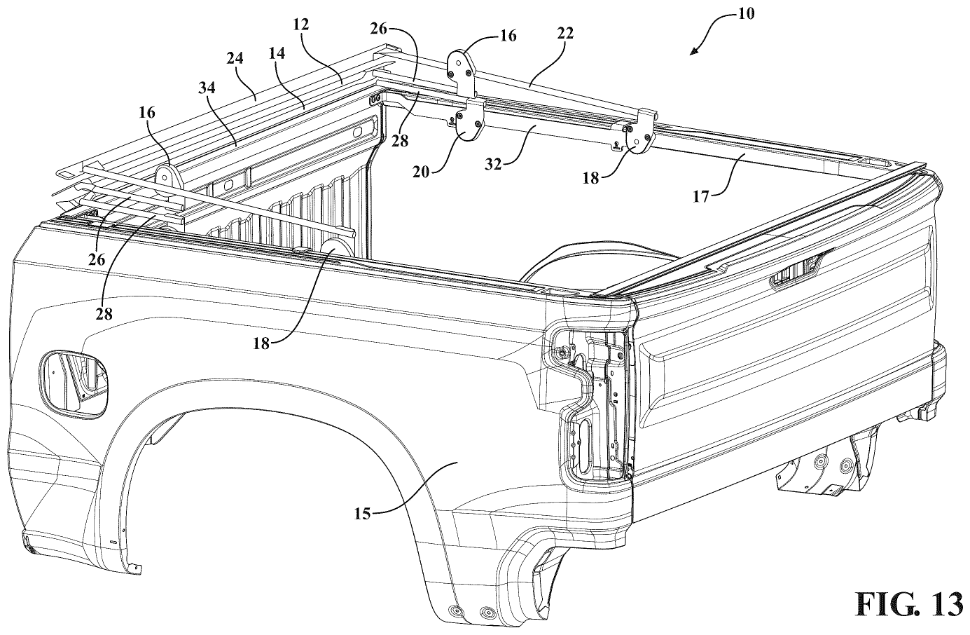

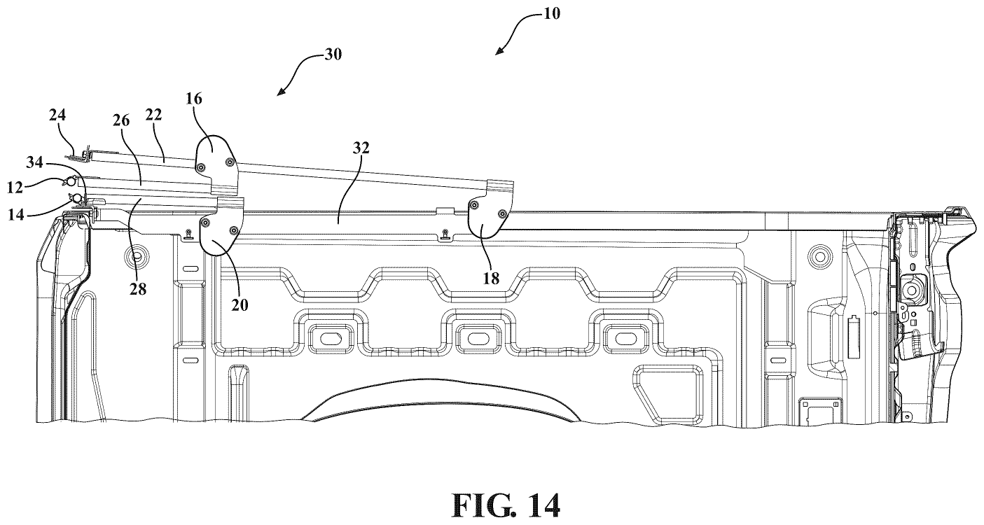

Referring to FIGS. 1-14 generally, the present invention provides a rotating clock spring fabric management for tonneau covers operably adapted for vehicles, e.g., pickup truck vehicles 15 including a cargo bed top opening 17. There is provided a fabric management soft tonneau assembly, indicated generally at 10, which is linkage free between a first and a second fabric management bow 12 and 14. Each bow 12,14 has respective pivot joints, e.g., first 16, second 18, and third 20 pivot joints, operably coupled on either side (preferably on both sides) with all having biasing members. Most preferably, clock spring biasing in the direction of the arrows, e.g., see FIG. 5 in closed position). The assembly 10 provides a pivotable portion, indicated generally at 30, operable to selectively at least partially uncover the cargo bed top opening 17 when desired. The pivotable portion 30 moves between a closed position closing off the cargo bed top opening 17 and an open position.

The first pair of pivot joints 16 are operably connected to a pair of first rails 22, and each pivot joint 16 is operably connected to an arm 26. The first fabric management bow 12 is operably connected toward the end of both arms 26,26.

A rear tensioning bow 24 is operably connected between the pair of first rails 22. Toward the other end of the pair of first rails 22, the pair of second pivot joints 16 are operably connected to the pair of first rails 22. The pair of second pivot joints 16 are each operably connected to a respective frame 32 adjacent the opening 17. The rear tensioning bow 24 is operably connected to the cover 25 of predetermined material.

The third pair of pivot joints 20 are operably connected to the opposing frames 32. The third pivot joints 20 are operably connected to a pair of second arms 28. The second fabric management bow 14 is operably connected toward the end of both second arms 28,28. A front tensioning frame 34 is operably connected toward both ends to the opposing frames 32,32. The cover 25 is operably connected to the front tensioning frame 34.

At rest, the first and second pivot joints 16 and 20 are biased in opposite directions, such that the first bow 12 (e.g., bow nearer the rear of the vehicle 15 adjacent a tailgate) and second bow 14 (e.g., bow nearer the front cab of the vehicle 15) are biased away from each other. The tonneau cover also uses the tonneau top with pivots and springs, e.g., pivot joints 16,18,20, to fold the tonneau back. Alternative configurations, combinations, and biasing direction(s) are contemplated without departure from the scope of the present invention.

Each bow 12 and 14 has a pivot on either side (or both) which all have a clock spring biasing generally in the direction of the arrows, e.g., FIG. 5. At rest, the first bow 12 and second bow 14 are biased away from each other. The springs interact with respective predetermined loads.

The tonneau cover easily selectively opens to an open cargo bed position by pulling/pushing the assemblies rear tensioning bow 24 generally upward and the top cover tilts on first and third pivots 16 and 20 back while the second pivot 18 dampens the movement as the top moves to the open position, and also provides an assist when closing. The top may stay in the open position even if there is no catch to hold it there. A simple pawl type safety catch can be used if desired. To close the top, generally upward pressure is placed on the rear tensioning bow 24 or pivotable portion 30 member and then the whole unit pivots back with an assist to the closed position.

Alternative configurations, combinations, and biasing direction(s) are contemplated without departure from the scope of the present invention.

The springs at pivots 16 and 20 are biased away from each other to maintain the fabric tension. In particular, the springs help to load the bows (respective bows 12 and 14), and when the top is opening, the bows manage the fabric 25.

The spring at pivot 18 is biased toward closing the tonneau top in order to dampen the fall of the top into the open tonneau position, and to assist the top balance when closing to the closed position.

The first and second bows 12,14 may optionally be connected by fabric straps which supports the top fabric 25 in the closed position in accordance with aspects of the present invention.

The cover is a preferably a soft material, e.g., fabric material, soft or flexible material, vinyl or any other suitable material and combinations thereof depending on the application.

No links between the fabric management bows 12,14. No spin riveting is necessary at any of the pivots. The rear tensioning bow 24 operably comes to rest where it is supposed to, rather than pull back a little so as to make it hard to close at the rear of the vehicle.

It is understood that the right side of the assembly 10 is preferably substantially a mirror image to the left side of the assembly 10.

The description of the invention is merely exemplary in nature and, thus, variations that do not depart from the essence of the invention are intended to be within the scope of the invention. Such variations are not to be regarded as a departure from the spirit and scope of the invention.

What is claimed is:

1. A soft tonneau top cover assembly operably adapted for a pickup truck vehicle, comprising:
a first fabric management bow;
a pair of first arms operably connected to said first fabric management bow;
a second fabric management bow;
a pair of second arms operably connected to said second fabric management bow;
a plurality of operably biased pivots, operable to dampen the movement of the soft tonneau top cover and provide a lift assist when selectively moving between at least a closed position and open position, said pairs of first arms and second arms operably connected to said plurality of operably biased pivots.

2. The soft tonneau top cover assembly of claim 1, further comprising at least one pair of front rails operably connected to a front tensioning bow selectively connectable to the vehicle in the closed position, wherein said front tensioning bow is operably connected to and tensions a fabric cover when in said closed position.

3. The soft tonneau top cover assembly of claim 1, wherein the plurality of operable biased pivots includes a pair of first pivots operably connected to a pair of front rails of a pivotable portion of said soft tonneau top cover.

4. The soft tonneau top cover assembly of claim 1, further comprising a pair of front rails operably connected to a first and second biased pivot of said plurality of operably biased pivots.

5. The soft tonneau top cover assembly of claim 1, further comprising a cover, wherein said first and second fabric management bows is operably coupled to said and manages a said cover when folding to said open position.

6. The soft tonneau top cover assembly of claim 1, wherein the plurality of operable biased pivots includes at least a pair of first pivots and a second pair of pivots operably connected to a pair of front rails movable with a pivotable portion of said soft tonneau top cover to a said open position.

7. The soft tonneau top cover assembly of claim 6, wherein the plurality of operable biased pivots further includes a pair of third pivots operably connected to a frame operably connected to the vehicle.

8. The soft tonneau top cover assembly of claim 1, wherein when said soft tonneau top cover assembly is at rest in said closed position, said first and second fabric management bows are biased away from each other.

9. The soft tonneau top cover assembly of claim 1, wherein one of said plurality of operably biased pivots is operably connected to one of said first arms, and another of said plurality of operably biased pivots is operably connected to one of said second arms.

10. The soft tonneau top cover assembly of claim 1, wherein said plurality of operable biased pivots incorporate clock spring biasing.

11. The soft tonneau top cover assembly of claim 1, further comprising a frame member operably connected to the vehicle, wherein two separate pairs of said plurality of operable biased pivots are operably connected to said frame member.

12. The soft tonneau top cover assembly of claim 1, wherein said plurality of operably biased pivots comprises:
a first pivot joint plurality of operably biased pivots on at least one side of said soft tonneau top cover assembly operably connected to one of said first arms operably connected to said first fabric management bow;
a front rail operably connected to said first pivot joint;
a second pivot joint of said plurality of operably biased pivots on at least one side of said soft tonneau top cover assembly operably connected to said front rail;
a third pivot joint plurality of operably biased pivots on at least one side of said soft tonneau top cover assembly operably connected to one of said second arms operably connected to said second fabric management bow,
wherein said first and third pivot joints are biased in opposite directions when said soft tonneau top cover assembly is in the closed position.

13. The soft tonneau top cover assembly of claim 12, wherein said second pivot joint is biased in the same direction as the first pivot joint when the soft tonneau top cover assembly is in the closed position and operably dampens the movement of the soft tonneau top cover when rotating down into the open position.

14. The soft tonneau top cover assembly of claim 13, further comprising a pivotable portion of said soft tonneau top cover assembly that opens to said open position by applying substantially upward pressure to said pivotable portion causing said pivotable portion to rotate in a first direction on said first and third pivot joints while the second pivot joint dampens the movement of the pivotable portion, and also operably provides a biased assist when rotating in a second direction to said closed position.

15. A soft tonneau top cover assembly operably adapted for connecting at a cargo bed top opening of a vehicle, comprising:
a cover;
at least two fabric management bows operably coupled to said cover; and
a plurality of operably biased pivots, operable to dampen the movement of a pivotable portion of the soft tonneau top cover assembly and also to provide a lift assist to said soft tonneau top cover assembly, said soft tonneau top cover assembly selectively movable between at least an open position and a closed position, wherein said at least two fabric management bows manage the cover when folding to said open position.

16. The soft tonneau top cover assembly of claim 15, further comprising a pair of rails operably connected to a cover tensioning bow and to two pairs of said plurality of operably biased pivots.

17. The soft tonneau top cover assembly of claim 15, wherein at least two of said plurality of operably biased pivots are biased in opposite directions with respect to each other to maintain cover tension in the closed position.

18. The soft tonneau top cover assembly of claim 15,
a pair of first arms operably connected to one of said fabric management bows; and
a pair of second arms operably connected to another of said fabric management bows,
wherein said pair of first arms is operably rotatably connected to a first pivot joint pair of said plurality of operably biased pivots and said pair of second arms is operably connected to another pivot joint pair of said plurality of operably biased pivots, wherein said first and other pivot joint pairs are biased in opposite directions when said soft tonneau top cover assembly is in the closed position.

19. The soft tonneau top cover assembly of claim 15, wherein said plurality of operably biased pivots comprises:
a first pivot joint plurality of operably biased pivots on at least one side of said soft tonneau top cover assembly operably connected to one of said first arms operably connected to said first fabric management bow;
a front rail operably connected to said first pivot joint;
a second pivot joint of said plurality of operably biased pivots on at least one side of said soft tonneau top cover assembly operably connected to said front rail;
a third pivot joint plurality of operably biased pivots on at least one side of said soft tonneau top cover assembly operably connected to one of said second arms operably connected to said second fabric management bow,
wherein said first and third pivot joints are biased in opposite directions when said soft tonneau top cover assembly is in the closed position and said plurality of biasing pivots operably assist and operable dampen the at least two fabric management bows when moving the soft tonneau top cover assembly to/from said closed position and open positions.

20. A soft tonneau top cover assembly operably adapted for a cargo bed of a vehicle, comprising:
a cover operable to selectively close off a cargo bed top opening;
at least two fabric management bows, wherein said soft tonneau top cover assembly has no linkages between said at least two fabric management bows;
a plurality of biased pivot joints incorporating springs, wherein said springs of two of said pivot joints are biased away from each other to load said two fabric management bows and, when the soft tonneau top cover assembly is opening, said at least two fabric management bows manage said cover,
wherein the spring of another pivot joint is located between the said two pivot joints and is biased toward closing the soft tonneau top cover assembly in order to dampen the fall of the soft tonneau top cover assembly into an open position and to assist the soft tonneau top cover assembly balance when closing to a closed position.
